(19) United States
(12) Patent Application Publication
(10) Pub. No.: US 2026/0037787 A1
(43) Pub. Date: Feb. 5, 2026

(54) SHUNTING INHIBITION FOR MULTIPLICATION IN NEUROMORPHIC ARCHITECTURES

(71) Applicant: National Technology & Engineering Solutions of Sandia, LLC, Albuquerque, NM (US)

(72) Inventors: Suma George Cardwell, Albuquerque, NM (US); Frances S. Chance, Albuquerque, NM (US)

(21) Appl. No.: 18/790,241

(22) Filed: Jul. 31, 2024

(51) Int. Cl. G06N 3/063

(52) U.S. Cl. CPC G06N 3/063

(57) ABSTRACT

A method of shunting inhibition mechanism in a neuromorphic circuit is provided. The method comprises inputting excitatory signals to an artificial neuron soma having a resting membrane potential. Shunting conductances are input to the artificial neuron soma to multiply response to the excitatory signals in the artificial neuron soma, wherein the shunting conductances have a reversal potential approximately equal to the resting membrane potential of the artificial neuron, and wherein increasing the shunting conductances increases membrane conductance of the artificial neuron soma.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

### 1. Field

The present disclosure relates generally to artificial neural networks and more specifically to systems and methods for multiplication in neuromorphic architectures by using shunting inhibition in conjunction with excitatory signals.

### 2. Background

Biological neurons are commonly described as performing a weighted sum of their synaptic inputs and then spiking. However, they are also capable of a wide range of nonlinear operations. For example, the effects of covert attention in visual cortex, gaze-direction on visual responses in parietal cortex, multi-sensory integration in flies, and local contrast normalization have all been described as multiplicative effects, where one input modality multiplicatively or divisively scales a neuron's response to a second input.

Multiplication is a critical component of recent models proposing coordinate transformations for visually guided reaching, translation-invariant object recognition, interception, sound localization, and motion-sensitivity. The widespread appearance of multiplicative-like operations across a range of biological neural systems as well as models of representations and transformations by neural circuitry suggests multiplication as a canonical computation performed by biological nervous systems.

Multiplication is also a key operation for computing. The complexity of many algorithms depends on how fast the multiplication can be performed. However, it is a costly operation. In fact, a lot of current hardware accelerators propose efficiently executing MAC (Multiply-Accumulate) operations as they are key to many algorithms such as Artificial Intelligence/Machine Learning (AI/ML), linear algebra etc. Analog approaches using crossbars with nonvolatile memory devices have also gained considerable interest in recent times due to their low computational costs while doing large matrix multiplications.

Therefore, it would be desirable to have a method and apparatus that take into account at least some of the issues discussed above, as well as other possible issues.

### SUMMARY

An illustrative embodiment provides a method of shunting inhibition in neuromorphic architectures. The method comprises inputting excitatory signals (which may be conductance based) to an artificial neuron having a resting membrane potential. Shunting conductances are input to the artificial neuron soma to multiply response to the excitatory signals in the artificial neuron soma, wherein the shunting conductances have a reversal potential approximately equal to the resting membrane potential of the artificial neuron, and wherein increasing the shunting conductances increases membrane conductance of the artificial neuron soma without changes in the resting membrane potential.

An illustrative embodiment provides a neuromorphic circuit, comprising: an artificial neuron soma having a resting membrane potential; a number of excitatory signals input to the artificial neuron soma; and a number of shunting conductances input to the artificial neuron soma, wherein the shunting conductances multiplicatively scale the excitatory signals in the artificial neuron soma, and wherein the shunting conductances have a reversal potential approximately equal to the resting membrane potential of the artificial neuron, and wherein increasing the shunting conductances increases membrane conductance of the artificial neuron soma without changes in the resting membrane potential.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a diagram of a single-compartment neuron model receiving excitatory and shunting input in accordance with an illustrating embodiment;

FIG. 2 depicts a diagram of an equivalent circuit of the single-compartment model neuron in accordance with an illustrative embodiment;

FIG. 3 depicts graphs illustrating excitatory and shunting inhibition conductances and the neuron's response as a function of time in accordance with an illustrative embodiment;

FIG. 4 depicts a graph illustrating the effect of shunting inhibition on neuronal responses to excitatory conductance-based input in accordance with an illustrative embodiment;

FIG. 5 depicts a graph illustrating the effect of shunting inhibition on neuronal responses to excitatory current input in accordance with an illustrative embodiment;

FIG. 6 depicts a diagram of a two-compartment dendrite circuit in accordance with an illustrative embodiment;

FIG. 7 depicts a graph illustrating the shunting inhibition mechanism in two-compartment neuromorphic dendrite cable in accordance with an illustrative embodiment;

FIG. 8 depicts a diagram of a single-compartment dendrite with excitatory input and a shunt input in accordance with an illustrative embodiment;

FIG. 9 depicts a diagram of a dendrite-enabled neural network in accordance with an illustrative embodiment;

FIG. 10 represents an example of successful interception trajectories as calculated by the dendrite-enabled dragonfly model in accordance with an illustrative embodiment;

FIG. 11 represents another example of successful interception trajectories as calculated by the dendrite-enabled dragonfly model in accordance with an illustrative embodiment; and

FIG. 12 depicts a flowchart illustrating a process for shunting inhibition in neuromorphic architectures in accordance with an illustrative embodiment.

### DETAILED DESCRIPTION

The illustrative embodiments recognize and take into account that evidence suggests that single biological neurons are capable of multiplication. We seek to design neuromorphic hardware that enables this complexity for a single neuromorphic neuron. Currently, most neuromorphic architectures use a point neuron model which limits algorithmic complexity. This configuration can sometimes translate to algorithms that require large numbers of neurons and dense connectivity that are untenable for current silicon systems. Modeling more complex neurons in neuromorphic hardware can have a big impact on algorithms that are targeted for these novel platforms.

The illustrative embodiments also recognize and take into account that mechanisms for multiplicative integration by single neurons remain poorly understood, although a number of biologically plausible mechanisms have been proposed. The illustrative embodiments utilize varying shunting inhibition, a conductance with reversal potential close to the resting membrane potential of a neuron, as a mechanism for producing multiplicative-like operations.

The illustrative embodiments provide a method and architecture that produces a multiplication-like effect using the shunting inhibition mechanism by varying leakage along the input line. The input sequence and shunt are used to modulate the output. This circuit can be generalized for different non-volatile emerging devices, and the tau of the circuit can be varied by programming different capacitance. Enabling computation in the interconnect of neuromorphic architectures has the potential to increase complexity in single neurons and reduce the energy footprint for neural networks.

An embodiment utilizes shunting inhibition in neuromorphic dendrites. Dendrites are biological “wires” that connect synapses to the soma of a neuron. Because of their highly branched, tree-like structures, it is thought that dendritic like architectures are required to achieve the dense connectivity observed in the brain. Also, dendrites have been shown to exhibit a range of linear and non-linear mechanisms that allow them to implement elementary computations. These properties are essential for computations performed by biological neurons, and it is hypothesized that they contribute to multiplicative integration observed in single neurons.

Some illustrative embodiments provide a multi-compartment neuromorphic dendritic model that produces a multiplication-like effect by varying leakage along the dendritic cable. Using leakage in this way is very much inspired by earlier modeling work that placed shunting inhibition along the “path” from more distal excitatory input to action potential generation at the soma. The advantages of modeling the multiplication-like effect in dendrites will be as follows: dendrites can be implemented with fewer transistors/resistive elements, enable spatiotemporal processing and nonlinear filtering of inputs, and add additional complexity to a neuron model.

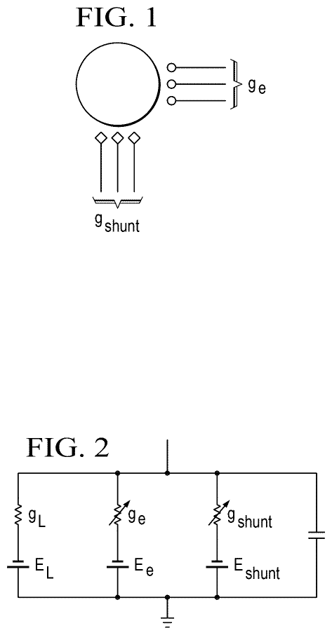

FIG. 1 depicts a diagram of a single-compartment neuron model receiving excitatory and shunting input in accordance with an illustrating embodiment. We first introduce shunting conductance, also referred to as shunting inhibition, in the context of a single-compartment model neuron. The model neuron receives excitatory (gₑ) and shunting (gₛₕᵤₙₜ) synaptic inputs. FIG. 2 depicts a diagram of an equivalent circuit of the single-compartment model neuron. The circuit conductance is in series with a battery that determines the reversal potential for that conductance, or the potential difference at which current ceases to flow across the conductance.

The membrane potential of the neuron is:

$$C \frac{d V}{dt} = {g}_{L} ( V - {E}_{L} ) + {g}_{e} ( V - {E}_{e} ) + {g}_{s h u n t} ( V - {E}_{s h u n t} )$$

where C is the capacitance of the neuron, gL is the resting membrane conductance (in the absence of any additional synaptic input) of the neuron, and gₑ and gₛₕᵤₙₜ are the excitatory and shunting conductances, respectively. E_{L} and Eₑ are the membrane potential of the neuron (in the absence of any synaptic input) and the reversal potential of the excitatory signal. The excitatory signal may comprise either current or conductance. Eₛₕᵤₙₜ is the reversal potential of the shunting conductance, which is equal to the resting membrane potential of the neuron.

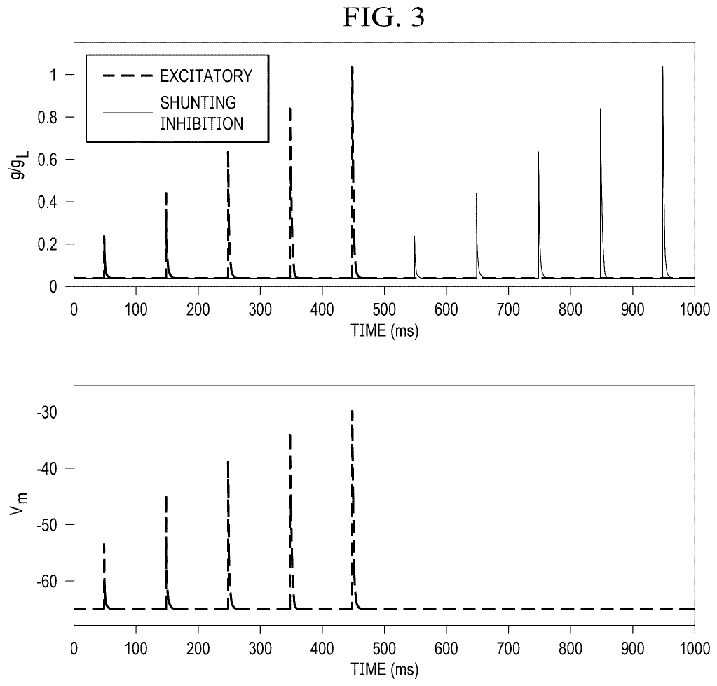

Because the reversal potential of the shunting conductance is equal to the resting membrane potential, increases in shunting conductance will increase the overall conductance of the neuron's membrane without affecting the membrane potential (if the neuron is at its resting membrane potential), as illustrated in FIG. 3. Excitatory conductance, gₑ, and inhibitory conductance, gₛₕᵤₙₜ, are plotted as a function of time. The trace in the bottom panel represents the membrane potential of the neuron, also as a function of time. Before 500 ms, rapid increases in gₑ result in upward deflections of the membrane potential. In contrast, rapid increases in g_{Shunt} (after time=500 ms) do not result in changes in the resting membrane potential. “Shunting inhibition” refers to any conductance that has a reversal potential close to or at the resting membrane potential of the neuron and has a suppressive effect on the response of that neuron.

Because shunting inhibition affects the overall conductance of the neuron without associated changes in membrane potential, several models predict that the dominant effect of shunting inhibition will be divisive. A subtractive, or additive, effect will result in a shifting of the neuronal response curve. In contrast, a divisive (or multiplicative scaling) effect results in a scaling of the response curve.

Studies of biological neurons have demonstrated the presence of time-varying shunt-like conductances in visual cortex, but the impact of shunting inhibition on the firing rate of biological neurons remains unclear. Evidence suggests that the impact of shunting inhibition on the firing rates of neurons depends on a number of factors, including the presence of noise, co-localizations of synaptic inputs, and the local configuration of the neural network, all of which can affect whether the impact of inhibition on the responses of a single neuron is subtractive, divisive, or a mix of both effects.

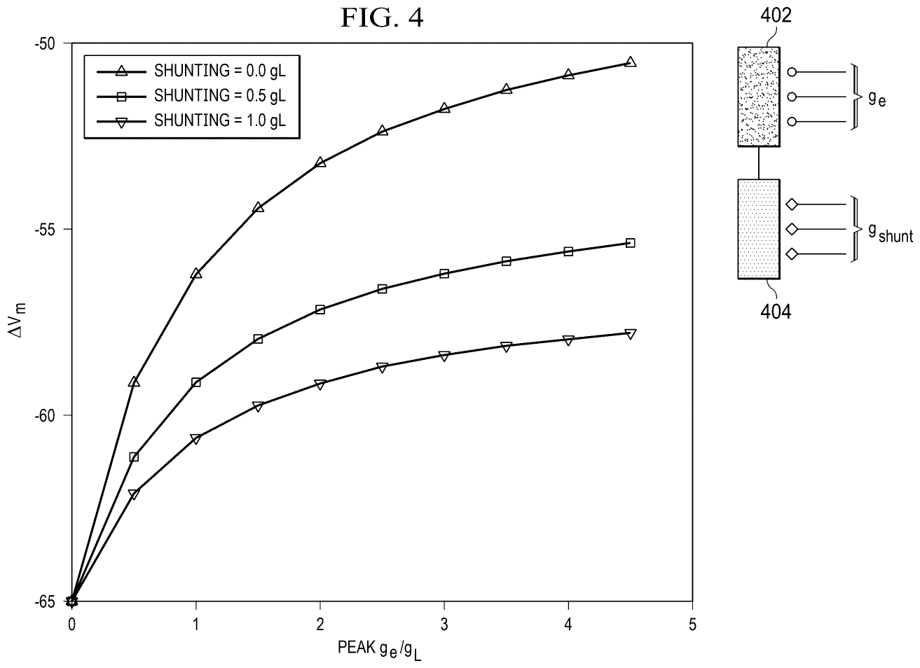

FIG. 4 depicts a graph illustrating the effect of shunting inhibition on neuronal responses to excitatory conductance-based input in accordance with an illustrative embodiment. FIG. 4 relates to a simple two-compartment dendritic model. Excitatory synaptic inputs drive changes in excitatory conductance, gₑ, in the top dendritic compartment 402. Inhibitory synaptic inputs, gₛₕᵤₙₜ, drive changes in shunting inhibition in the bottom dendritic compartment 404. The membrane potential in the first dendritic compartment 402, V₁ is

$$C \frac{d {V}_{1}}{dt} = {g}_{L} ( {V}_{1} - {E}_{L} ) + {g}_{e} ( {V}_{1} - {E}_{e} ) + {g}_{a} ( {V}_{1} - {V}_{2} )$$

Here gₐ=0.25 g_{L} is the axial conductance connecting the two dendritic compartments 402, 404. V₂ is the second compartment 404 in the dendritic model:

$$C \frac{d {V}_{2}}{dt} = {g}_{L} ( {V}_{2} - {E}_{L} ) + {g}_{s h u n t} ( {V}_{2} - {E}_{s h u n t} ) + {g}_{a} ( {V}_{2} - {V}_{1} )$$

Changes in excitatory synaptic conductance are modeled as transient increases in gₑ as in FIG. 3. FIG. 4 shows maximum membrane potential deflections measured in the second dendritic compartment 404 plotted as a function of peak gₑ input, for three levels of shunting inhibition. The different curves represent gₛₕᵤₙₜ equal to 0, 0.5 gL, and 1.0 gL, respectively. For this configuration of synaptic inputs, the effects of shunting inhibition on the membrane potential response to excitatory input arriving at a different dendritic compartment is not purely divisive. Mixed effects arise due to interactions between the shunting inhibition in one compartment and excitatory conductance changes in the other compartment.

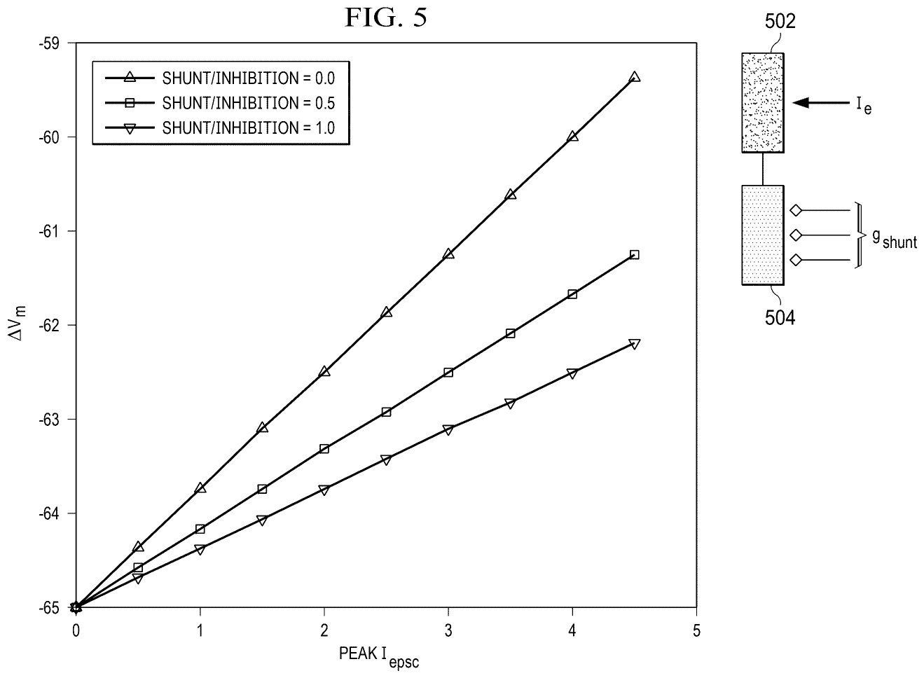

Models of shunting inhibition in biological brains often assume that shunting inhibition, impinging on the neuron close to the soma, controls the gain of a neuron's response to a second set of driving synaptic inputs located further away on the dendritic arbor. We create a similar configuration of excitatory synaptic input and shunting inhibition in our model by considering a scenario in which only shunting inhibition affects the overall conductance of the neuron. In this version of the model, excitatory signals arrive as injected current. This configuration of inputs is illustrated in the inset of FIG. 5.

FIG. 5 demonstrates peak membrane potential deflections as a function of peak excitatory input current for three levels of shunting inhibition. Excitatory current is injected into the first compartment 502 of the dendrite while shunting inhibition directly impacts the conductance of the second dendritic compartment 504. Membrane potential deflections are measured from the second dendritic compartment. For this configuration of inputs (excitatory input current into one dendritic compartment and shunting inhibition into the other), shunting inhibition has a divisive effect on the membrane potential responses to excitatory current.

Biological dendrites are known for their complex physical structures that incorporate significant fan-in (≈10,000 inputs) as well as the capability for individual branches to perform nonlinear operations independently of each other. These properties suggest that dendrites are a relevant computational component with significant potential for neuromorphic systems. A neuromorphic dendrite model can be leveraged for a multiplicative-like operation by changing the leakage of the cable.

There are efforts to leverage emerging devices, for example memristors or multi-gate ferroelectric FETs, to build artificial dendrites. These devices promise low-power solutions, can be integrated with CMOS (Complementary Metal-Oxide Semiconductor), and have the potential to leverage three-dimensional stacking techniques to increase connectivity that will amplify the advantages offered by neuromorphic dendrites.

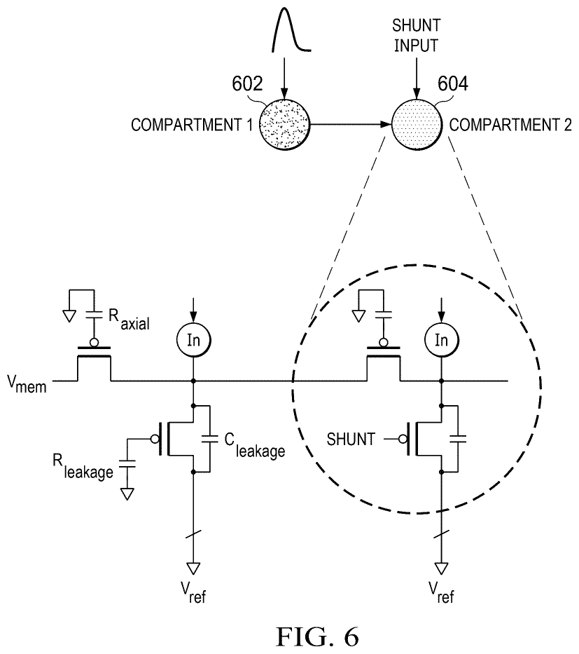

FIG. 6 depicts a diagram of a two-compartment dendrite circuit in accordance with an illustrative embodiment. Biological dendrites are modeled by assembling a series of compartments into a cable. A passive dendritic compartment can be modeled by a series of resistor-capacitor (RC) circuits. A RC circuit can be modeled using transistors in the linear sub-threshold regime and capacitors as shown in FIG. 6. Complex neuron models that incorporate dendritic connections would be very beneficial, especially if we come up with computationally efficient ways to implement dendrites. Analog approaches offer savings in energy compared to digital neuromorphic, with the promise of more complexity and dynamics.

We are interested in modeling shunting inhibition in dendrites for two reasons. First, for an analog dendrite model we can easily model changing the conductance (by changing leakage) of a given compartment, and second, if successful, this will be an inexpensive method to model a multiplication-like effect on spatio-temporal inputs along a dendrite cable.

We leverage the behavioral model of CMOS dendrites to simulate results of a dendrite cable, with and without the mechanism of shunting inhibition. We constructed a two-compartment dendrite, with each stage represented as shown in the circle in FIG. 6. Each dendrite compartment 602, 604 comprises an excitatory signal input, an axial conductance (Rₐₓᵢₐₗ), leakage conductance (R_{leakage}), and leakage capacitance (C_{leakage}). For the two-compartment dendrite, shunting inhibition is modeled on the end of the dendrite proximal to the neuron soma, which is the second or far-right compartment 604 in FIG. 6. (Note that the position of the soma, not drawn because it is not included in this model, should be to the right of this compartment.) The excitatory signal input current is modeled into the first compartment 602.

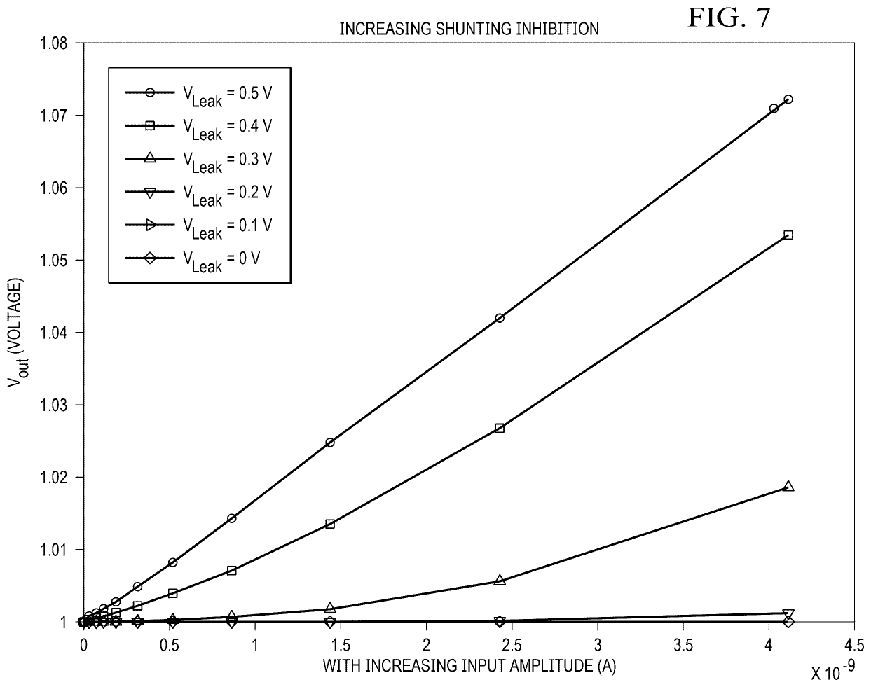

FIG. 7 depicts a graph illustrating the shunting inhibition mechanism in two-compartment neuromorphic dendrite cable in accordance with an illustrative embodiment. The x-axis represents increasing synaptic current, and the y-axis represents voltage (Vₒᵤₜ) at the second dendritic compartment 604.

For the simulation without shunting inhibition, V_{Axial}=0.5V is the gate voltage for the axial transistor, and V_{Leak}=0.5V is the gate voltage for the leakage transistor. The ‘-*’ line in FIG. 7 represents the condition without any shunting inhibition at the second dendritic compartment. The other ‘-o’ lines show the effect of shunting inhibition with increasing leakage values of the second dendrite compartment 604, with gate voltage of the leakage transistor V_{Leak} varying from 0 to 0.4 V. Because this is a pFET floating-gate transistor, the lower the gate voltage, the more “ON” the transistor is, and hence the greater the leakage. All constants are defined for the model based on the MOSFETS used on the field programmable analog array (FPAA) (thermal voltage U_{T}=25 mV, κ=0.846, Iₒ=0.1 fA, C_{leakage}=10 pF, V_{dd}=2.4V) along with the input parameters as defined E_{κ}=1V. FIG. 7 demonstrates a divisive-like effect as the leakage of the dendrite cable is increased, similar to the effect seen in FIG. 5.

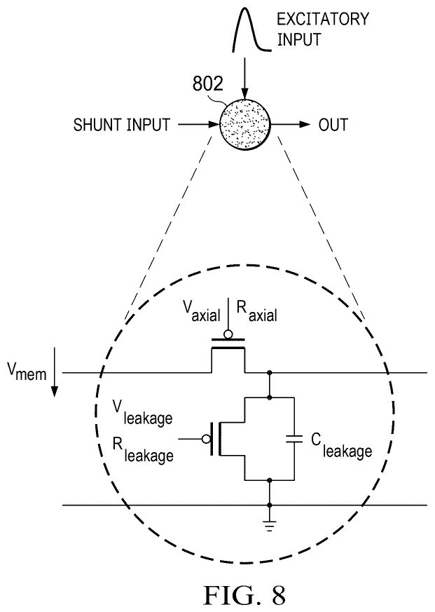

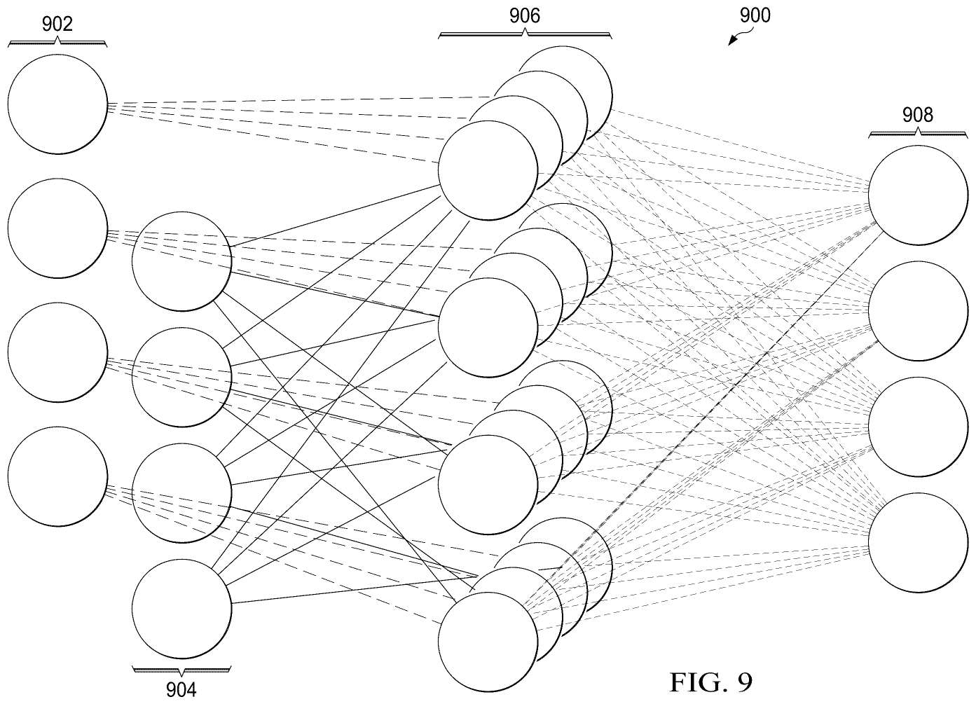

FIG. 8 depicts a diagram of a single-compartment dendrite with excitatory input and a shunt input in accordance with an illustrative embodiment. In this embodiment, both the excitatory input and shunt input are fed into the sample dendrite compartment 802. As with the two-compartment dendrite configuration in FIG. 6, Input multiplicatively scales the response to excitatory input, enabling multiplication of two independently time-varying inputs, a distinct operation from programmable fixed weights typically associated with a neural network.

FIG. 9 depicts a diagram of a dendrite-enabled neural network in accordance with an illustrative embodiment. In the present example, network 900 represents multiplication in a dragonfly-inspired neural network. Recent studies have demonstrated that the Drosophila nervous system builds representations (e.g. for navigation) by multiplying different streams of sensory input.

The input layer comprises two populations of neurons 902, 904. One population 902 receives visual input, for example from a camera. The response of visual neuron i is

$${f}_{i} = exp ( - \frac{{( x - {a}_{i} )}^{2}}{2 {σ}_{r}^{2}} )$$

where x is the location of the target's image on the camera's plane, αᵢ is the preferred target-image location of neuron i, and σᵣ determines the width of the tuning curve.

Neurons in the second population 904 of input neurons (referred to here as ‘fovea neurons’) encode the desired location of the target's image on the sensor (unlike a biological fovea, the model fovea is a variable location). Like visual neurons, the responses of fovea neurons are characterized by Gaussian tuning curves:

$${g}_{i} ( y ) = exp ( - \frac{{( y - {b}_{i} )}^{2}}{2 {σ}_{g}^{2}} )$$

where y is the fovea location, bⱼ is the preferred fovea location of neuron j, and σ_{g} determines the width of the tuning curve.

The response Sᵢⱼ of a single sensorimotor neuron is the product of input from visual-input neuron i and fovea neuron j:

$${S}_{i j} = {f}_{i} ( x ) {g}_{j} ( y )$$

The sensorimotor population therefore included neurons tuned for all possible combinations of target-image and fovea positions.

To demonstrate the viability of using shunting inhibition for multiplication in a neuromorphic application, network 900 replaces sensorimotor neurons 906 with multi-compartment neurons comprising a single dendritic compartment model such as shown in FIG. 8. (It should be noted that network 900 can also be implemented with two-compartment dendrites as shown in FIG. 6). The dendritic compartment enables multiplicatively scaling of the excitatory input by the shunt input. The excitatory input is sent to the dendrite by the visual neurons 902, and the shunt input is controlled by fovea neurons 904.

The dendrite compartment is modeled as a passive cable using transistors operating in the subthreshold regime. The subthreshold regime of transistors is dominated by diffusion much like biological processes with an exponential current-voltage relationship. We use Matlab code to solve the coupled ODEs (Ordinary Differential Equations) that capture the behavioral properties of this CMOS based Dendrite, which captures the subthreshold dynamics of a transistor.

For an n compartment dendrite, we solve for the voltage at each ‘tap’ of the dendrite. We define all the constants in the equations based on the transistors used on the FPAA (Field Programmable Analog Array) (Constants κ, I₀, thermal voltage U_{T}, capacitance C) along with the input parameters as defined for the block (leakage conductance modulated by V_{leakage}, axial conductance modulated by Vₐₓᵢₐₗ, potential Eₖ).

$$\vec{\frac{dv}{dt}} = \frac{1}{C} ( {a}_{1} \cdot {I}_{i n j} + {k}_{1} ( {e}^{{a}_{2} \cdot \frac{\vec{V}}{{U}_{T}}} - {e}^{{a}_{3} \cdot \frac{\vec{V}}{{U}_{T}}} ) + {k}_{1} ( {e}^{{a}_{4} \cdot \frac{\vec{V}}{{U}_{T}}} - {e}^{{a}_{5} \cdot \frac{\vec{V}}{{U}_{T}}} ) + {k}_{1} ( {e}^{{a}_{6} \cdot \frac{\vec{V}}{{U}_{T}}} - {e}^{\frac{{E}_{k}}{{U}_{T}}} ) + {I}_{b i a s} )$$

$$where$$

$$\vec{V} = [ {V}_{1} {V}_{2} {V}_{3} … {V}_{n} ]$$

α₁, α₂, α₃, α₄, α₅, and α₆ are constant matrices whose size is dependent on the number of stages/taps of the dendrite.

The motor-output neurons 908 encode the direction to which the dragonfly should turn. The response Rₖ of motor-output neuron k is a weighted sum over all inputs from the sensorimotor population:

$${R}_{k} = {\sum }_{i , j} {W}_{i j k} {S}_{i j}$$

The synaptic weight between sensorimotor neuron Sᵢⱼ and motor output neuron k is described by

$${W}_{i j} ∝ \int \int exp ( - \frac{{( y + z - {a}_{i} )}^{2} )}{2 {σ}_{r}^{2}} - \frac{{( y - {b}_{j} )}^{2} )}{2 {σ}_{q}^{2}} - \frac{{( z - {c}_{k} )}^{2} )}{2 {σ}_{m}^{2}} ) d y d z$$

where cₖ is the preferred turn direction for neuron k and σₘ is a parameter that controls the tuning of the motor neurons for turn direction. The dragonfly executes a change in yaw,

$$d = \frac{{\sum }_{k} {c}_{k} {R}_{k}}{{\sum }_{k} {R}_{k}}$$

decoded by performing a weighted average of motor output neuron activities. For simplicity, we constrain the dragonfly and its target to move in one plane of motion, which significantly reduces the size of the neural network.

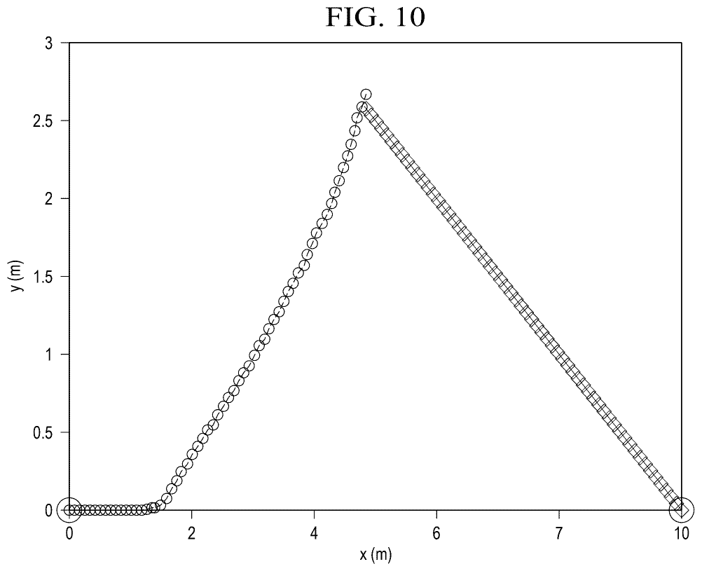

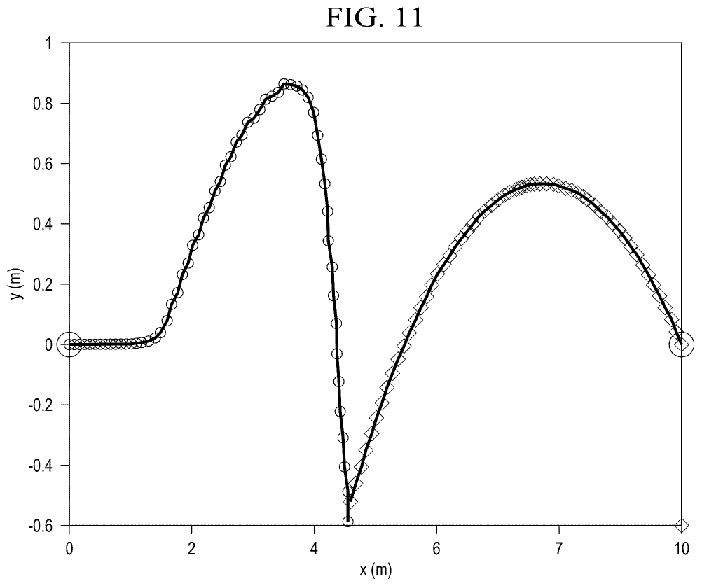

FIGS. 10 and 11 represent two examples of successful interception trajectories as calculated by the dendrite-enabled dragonfly model 900. The open circles represent the dragonfly. The filled circles represent the prey.

At the beginning of each simulation time step, the target moves to a new location (in plane of motion). The location of the target's image on the camera representing the dragonfly's eye determines the activities of the visual input neurons. The neural network model calculates the dragonfly's turn as described above and the dragonfly advances in the new direction. The new fovea location is calculated as e=e₀−d, where e₀ is the previous location of the fovea, and the activities of the fovea neurons are updated accordingly. This update is equivalent to shifting the fovea position in an equal but opposite direction to the shift in the target image's location on the camera that results from the dragonfly's turning.

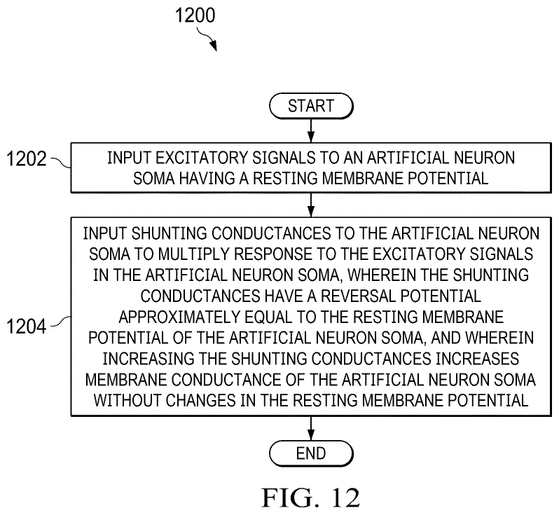

FIG. 12 depicts a flowchart illustrating a process for shunting inhibition in neuromorphic architectures in accordance with an illustrative embodiment. Process 1200 can be implemented in a neural network such as network 900.

Process 1200 begins by inputting excitatory signals to an artificial neuron soma having a resting membrane potential (1202).

Shunting conductances are input to the artificial neuron soma to multiply response to the excitatory signals in the artificial neuron soma (step 1204). The shunting conductances have a reversal potential approximately equal to the resting membrane potential of the artificial neuron soma. Increasing the shunting conductances increases membrane conductance of the artificial neuron soma without changes in the resting membrane potential.

Process 1200 then ends.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of shunting inhibition in a neuromorphic circuit, the method comprising:
inputting excitatory signals to an artificial neuron soma having a resting membrane potential; and
inputting shunting conductances to the artificial neuron soma to multiply response to the excitatory signals in the artificial neuron soma, wherein the shunting conductances have a reversal potential approximately equal to the resting membrane potential of the artificial neuron, and wherein increasing the shunting conductances increases membrane conductance of the artificial neuron soma.

2. The method of claim 1, wherein the shunting conductances determine relative weights for the excitatory signals entering the artificial neuron soma.

3. The method of claim 1, wherein the excitatory signals and shunting conductances are fed into a neuromorphic dendrite leading to the artificial neuron soma.

4. The method of claim 3, wherein the neuromorphic dendrite comprises a single compartment into which both the excitatory signals and shunting conductances are fed.

5. The method of claim 4, wherein the compartment comprises a resistor-capacitor circuit.

6. The method of claim 5, wherein resistor-capacitor circuit comprises an excitatory input, an axial conductance, leakage conductance, and leakage capacitance.

7. The method of claim 3, wherein the wherein the neuromorphic dendrite comprises two compartments, wherein the excitatory signals are fed into a first compartment, and the shunting conductances are fed into a second compartment, wherein the second compartment is between the first compartment and the artificial neuron soma.

8. The method of claim 7, wherein each compartment comprises a resistor-capacitor circuit.

9. The method of claim 8, wherein each resistor-capacitor circuit comprises an excitatory input, an axial conductance, leakage conductance, and leakage capacitance.

10. The method of claim 1, wherein the artificial neuron soma is one of a number of artificial neuron somas in a hidden layer of a neural network, wherein the excitatory signals are input by a first layer of input neurons, and wherein the shunting conductances are input by a second layer of input neurons.

11. A neuromorphic circuit, comprising:
an artificial neuron soma having a resting membrane potential;
a number of excitatory signals input to the artificial neuron soma; and
a number of shunting conductances input to the artificial neuron soma, wherein the shunting conductances multiplicatively scale the excitatory signals in the artificial neuron soma, and wherein the shunting conductances have a reversal potential approximately equal to the resting membrane potential of the artificial neuron, and wherein increasing the shunting conductances increases membrane conductance of the artificial neuron soma.

12. The neuromorphic circuit of claim 11, wherein the shunting conductances determine relative weights for the excitatory signals entering the artificial neuron soma.

13. The neuromorphic circuit of claim 11, wherein the excitatory signals and shunting conductances are fed into a neuromorphic dendrite leading to the artificial neuron soma.

14. The neuromorphic circuit of claim 13, wherein the neuromorphic dendrite comprises a single compartment into which both the excitatory signals and shunting conductances are fed.

15. The neuromorphic circuit of claim 14, wherein the compartment comprises a resistor-capacitor circuit.

16. The neuromorphic circuit of claim 15, wherein resistor-capacitor circuit comprises an excitatory input, an axial conductance, leakage conductance, and leakage capacitance.

17. The neuromorphic circuit of claim 13, wherein the wherein the neuromorphic dendrite comprises two compartments, wherein the excitatory signals are fed into a first compartment, and the shunting conductances are fed into a second compartment, wherein the second compartment is between the first compartment and the artificial neuron soma.

18. The neuromorphic circuit of claim 17, wherein each compartment comprises a resistor-capacitor circuit.

19. The neuromorphic circuit of claim 18, wherein each resistor-capacitor circuit comprises an excitatory signal input, an axial conductance, leakage conductance, and leakage capacitance.

20. The neuromorphic circuit of claim 11, wherein the artificial neuron soma is one of a number of artificial neuron somas in a hidden layer of a neural network, wherein the excitatory signals are input by a first layer of input neurons, and wherein the shunting conductances are input by a second layer of input neurons.
